(19) United States
(12) Patent Application Publication
(10) Pub. No.: US 2026/0197027 A1
(43) Pub. Date: Jul. 9, 2026

(54) TRANSMIT SPECTRAL SHAPING FOR REDUCING DISTORTION IN A RECEIVER

(71) Applicant: Telefonaktiebolaget LM Ericsson (publ), Stockholm (SE)

(72) Inventors: Mats BLOMGREN, Rüfenacht (CH); Sumedh DHABU, Toronto (CA); Mark WYVILLE, Ottawa (CA)

(21) Appl. No.: 19/132,120

(22) PCT Filed: Nov. 28, 2022
(86) PCT No.: PCT/IB2022/061489

§ 371 Date: May 22, 2025

(51) Int. Cl. H04B 1/525; H04B 15/04

(52) U.S. Cl. CPC H04B 1/525; H04B 15/04

(57) ABSTRACT

A method, system and apparatus for transmit spectral shaping for reducing distortion in a receiver are disclosed. According to one aspect, a method in a network node includes determining a spectral shaping filter for each of a plurality of sub-bands, each sub-band of the plurality of sub-bands being within a band that includes a carrier of a set of carriers, the spectral shaping filter for a sub-band being based at least in part on an intermodulation distortion (IMD) that overlaps with at least one sub-band of the plurality of sub-bands. The method also includes applying the spectral shaping filters to the sub-bands of the plurality of sub-bands.

### TECHNICAL FIELD

The present disclosure relates to wireless communications, and in particular, to transmit spectral shaping for reducing distortion in a receiver.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

It is a known design option to configure the power of transmit carriers beyond the capability of the average power handling of the power amplifier. This design option relies on the multiple carriers having independent traffic loads when looked at with a time resolution that corresponds to a scheduling interval (e.g., a transmission time interval (TTI)). As more carriers are added, this independence may reduce the probability that the sum of power in all of the carriers may exceed the actual power handling of the power amplifier. This probability is not zero, so there is typically some method that limits the total amount of power of the combined signal prior to the power amplifier such that it does not exceed the capability of the power amplifier. A purpose of the design option to under-dimension the power amplifier is to take advantage of a lower cost power amplifier. Another purpose is to enable a radio with a desired capability, even when the desired power amplifier capability is not commercially available.

Intermodulation distortion may be caused by at least some of the transmit carriers affecting the receiver. Intermodulation distortion is a signal that is generated by some non-linear physical mechanism like a passive intermodulation (PIM) source, or a power amplifier. The shape of the frequency spectrum of the intermodulation distortion signal may be predicted using information about the transmit carriers and a model of the source of intermodulation distortion. The information about the transmit carriers may simply be their frequency spectrum, and the model of the intermodulation source may be as simple as assuming a 3^{rd} order non-linearity.

Intermodulation distortion may fall into the frequency band where the receiver is configured. In this case, the intermodulation distortion may desensitize the receiver, thereby degrading the receiver performance.

Typically, desensitization of the receiver due to intermodulation generated in the power amplifier is handled by the combination of a power amplifier linearization solution and a radio frequency (RF) filter that isolates the signals from the transmitter in the uplink (UL) band from signals in the receiver in the UL band.

Typically, desensitization of the receiver due to intermodulation generated in some PIM component is handled by PIM testing in the factory and on the radio site after installation. These methods do not guarantee a world of PIM-free operation.

PIM sources may degrade over time, or PIM sources may exist that cannot be removed, such as some metal structures on a radio site.

Typically desensitization of the receiver due to intermodulation generated in the receiver is handled by a combination of a highly linear receiver and RF filter that isolates the signals form the transmitter in the DL band form signals in the receiver in the DL band.

### SUMMARY

A problem with current solutions that limit the input signal into an under-dimensioned power amplifier is that this limiting operation is not performed in a manner that seeks to minimize the receiver desensitization when the transmit carriers are creating intermodulation distortion.

Another problem with current solutions is that the requirements on the RF filters, transmitter linearization, receiver linearity and any passive components are stringent to minimize the effects of intermodulation distortion on receiver sensitivity. In these cases ‘stringent’ typically results in higher costs. The requirements may be based on the operation of the under-dimensioned power amplifier with some power limiting solution in place.

Some embodiments advantageously provide methods and network nodes for transmit spectral shaping for reducing distortion in a receiver.

Some embodiments provide a PIM-aware power limiting solution, where power is limited in a manner that tries to reduce the impact on some part of the UL frequency range being used. Some embodiments apply to reduce PIM and some embodiments apply to reduce active intermodulation involving the power amplifier and receiver components.

Instead of reducing the power of all transmit carriers, some embodiments apply different power reductions to different carriers in a manner that will: i) reduce the intermodulation distortion (IMD) in some part of the UL frequency range and ii) adhere to the power limit. Some embodiments include constraining the shape in the frequency domain of at least 1 of the transmit carriers in a manner that i) reduces the IMD in some part of the UL, and ii) adheres to the power limit.

Transmit (TX) shaping refers to having TX ‘shape’ other than a conventional rectangular shape. As an example, the shaping may be a linearly increasing power spectral density (PSD) from one side of the transmit carrier to the other.

A power limiting solution that reduces and/or shapes at least 1 of the transmit carriers in a manner that will reduce the impact of IMD on some part of an UL frequency using a TX spectral shaping filter is disclosed.

Some embodiments result in less receiver desensitization when a PIM source is present. The solution may also be used to put less stringent requirements on the RF filter, transmitter linearization, receiver linearity, and passive components in comparison to a similar system that uses some prior-art power limiting.

According to one aspect, a method in a network node configured to communicate with a wireless device, WD, is provided. The method includes determining a spectral shaping filter for each of a plurality of sub-bands, each sub-band of the plurality of sub-bands being within a band that includes a carrier of a set of carriers, the spectral shaping filter for a sub-band being based at least in part on an intermodulation distortion, IMD, that overlaps with at least one sub-band of the plurality of sub-bands. The method also includes applying the spectral shaping filters to the sub-bands of the plurality of sub-bands.

According to this aspect, in some embodiments, at least one spectral shaping filter is a digital filter having coefficients determined based at least in part on the overlapping IMD for at least one carrier of the set of carriers. In some embodiments, at least one spectral shaping filter is determined based at least in part on an effect of a selected spectral shaping filter upon the overlapping IMD for each of at least one carrier of the set of carriers. In some embodiments, the effect of the selected spectral shaping filter is indicated at least by a strength of the overlapping IMD for at least one carrier of the set of carriers. In some embodiments, the effect of the selected spectral shaping filter is indicated at least by an extent of overlap of the overlapping IMD with a sub-band of the plurality of sub-bands. In some embodiments, the selected spectral shaping filter is indicated at least by a receiver degradation metric. In some embodiments, the set of carriers includes at least one downlink carrier and at least one uplink carrier. In some embodiments, at least one spectral shaping filter is determined based at least in part on at least one of a downlink power, frequency and bandwidth and an uplink frequency and bandwidth of a carrier of the set of carriers. In some embodiments, a gain of at least one spectral shaping filter is based at least in part on a dynamic load utilization of a carrier of the set of carriers. In some embodiments, a gain of at least one spectral shaping filter varies with frequency. In some embodiments, at least one spectral shaping filter is determined in the frequency domain. In some embodiments, at least one spectral shaping filter is determined in the time domain. In some embodiments, the method includes selecting a shape of at least one spectral shaping filter from a set of spectral shaping filter shapes. In some embodiments, the IMD is estimated based at least in part on a model. In some embodiments, the model is trained according to a constrained optimization problem subject to a constraint on total downlink power.

According to another aspect, a network node is configured to communicate with a wireless device, WD. The network node includes a power limiter controller configured to determine a spectral shaping filter for each of a plurality of sub-bands, each sub-band of the plurality of sub-bands being within a band that includes a carrier of a set of carriers, the spectral shaping filter for a sub-band being based at least in part on an intermodulation distortion, IMD, that overlaps with at least one sub-band of the plurality of sub-bands. The network node also includes a plurality of power limiters in communication with the power limiter controller, each power limiter configured to apply a spectral shaping filter to a sub-band of the plurality of sub-bands.

According to this aspect, in some embodiments, at least one spectral shaping filter is a digital filter having coefficients determined based at least in part on the overlapping IMD for at least one carrier of the set of carriers. In some embodiments, at least one spectral shaping filter is determined based at least in part on an effect of a selected spectral shaping filter upon the overlapping IMD for each of at least one carrier of the set of carriers. In some embodiments, the effect of the selected spectral shaping filter is indicated at least by a strength of the overlapping IMD for at least one carrier of the set of carriers. In some embodiments, the effect of the selected spectral shaping filter is indicated at least by an extent of overlap of the overlapping IMD with a sub-band of the plurality of sub-bands. In some embodiments, the selected spectral shaping filter is indicated at least by a receiver degradation metric. In some embodiments, the set of carriers includes at least one downlink carrier and at least one uplink carrier. In some embodiments, at least one spectral shaping filter is determined based at least in part on at least one of a downlink power, frequency and bandwidth and an uplink frequency and bandwidth of a carrier of the set of carriers. In some embodiments, a gain of at least one spectral shaping filter is based at least in part on a dynamic load utilization of a carrier of the set of carriers. In some embodiments, a gain of at least one spectral shaping filter varies with frequency. In some embodiments, shaping of at least one spectral shaping filter is performed in the frequency domain. In some embodiments, shaping of at least one spectral shaping filter is performed in the time domain. In some embodiments, the processing circuitry is configured to select a shape of at least one spectral shaping filter from a set of spectral shaping filter shapes. In some embodiments, the IMD is estimated based at least in part on a model. In some embodiments, the model is trained according to a constrained optimization problem subject to a constraint on total downlink power.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for transmit spectral shaping for reducing distortion in a receiver;

FIG. 8 is a block diagram of a spectral shaping unit configured according to principles set forth herein;

FIG. 9 is a block diagram of a power limiter configured according to principles disclosed herein;

FIG. 10 illustrates a process for determining a spectral filter shape according to principles set forth herein;

FIG. 11 are graphs of power spectral density (PSD) filter shapes;

FIG. 12 are graphs of PSD for different spectral filter shapes; and

FIG. 13 is a block diagram of a non-linear model for determining a spectral filter shape according to principles disclosed herein.

### DETAILED DESCRIPTION

Before describing in detail example embodiments, it is noted that the embodiments reside primarily in combinations of apparatus components and processing steps related to transmit spectral shaping for reducing distortion in a receiver. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from employing the principles covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide transmit spectral shaping for reducing distortion in a receiver.

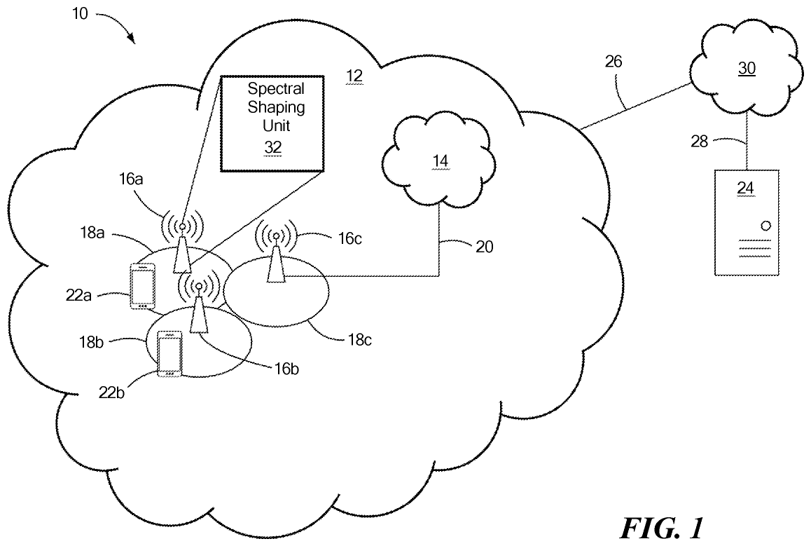

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a spectral shaping unit 32 which is configured to determine a spectral shaping filter for each of a plurality of sub-bands, each sub-band of the plurality of sub-bands being within a band that includes a carrier of a set of carriers, the spectral shaping filter for a sub-band being based at least in part on an intermodulation distortion (IMD) that overlaps with at least one sub-band of the plurality of sub-bands.

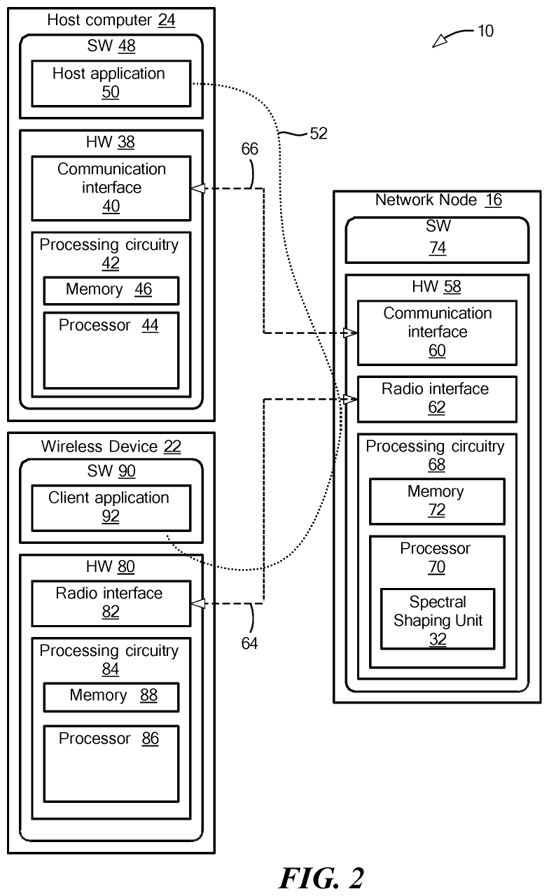

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a spectral shaping unit 32 which is configured to determine a spectral shaping filter for each of a plurality of sub-bands, each sub-band of the plurality of sub-bands being within a band that includes a carrier of a set of carriers, the spectral shaping filter for a sub-band being based at least in part on an intermodulation distortion (IMD) that overlaps with at least one sub-band of the plurality of sub-bands.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as spectral shaping unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

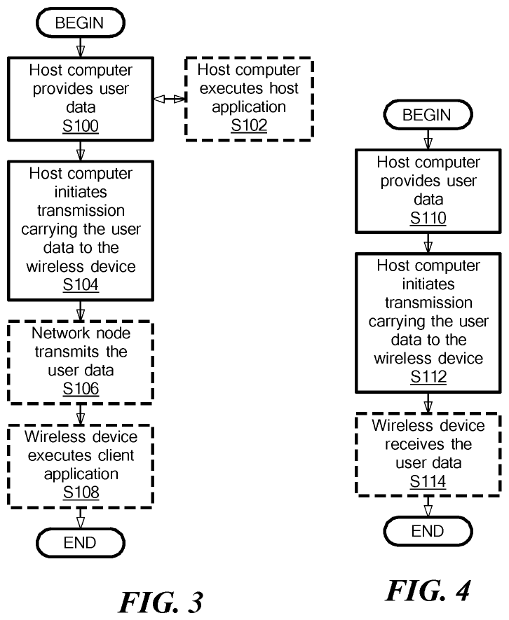

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

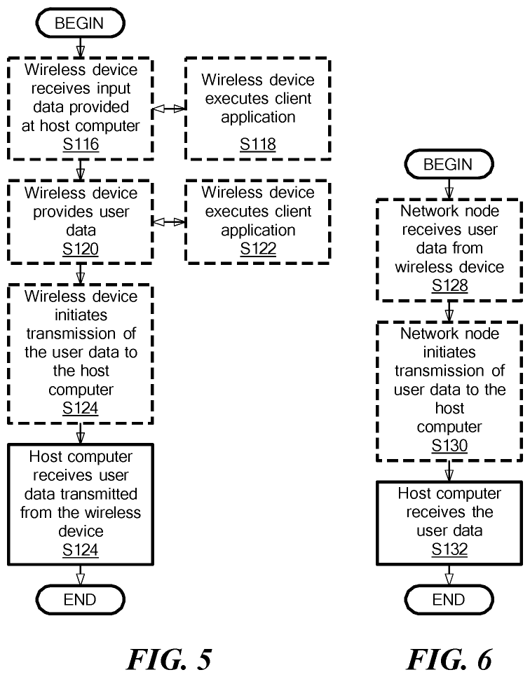

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

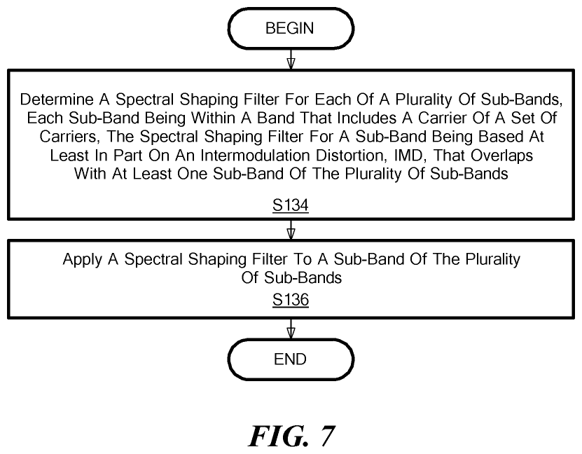

FIG. 7 is a flowchart of an example process in a network node 16 for transmit spectral shaping for reducing distortion in a receiver. One or more blocks described herein may be performed by one or more elements of network node 16 such as by one or more of processing circuitry 68 (including the spectral shaping unit 32), processor 70, radio interface 62 and/or communication interface 60. Network node 16 such as via processing circuitry 68 and/or processor 70 and/or radio interface 62 and/or communication interface 60 is configured to determine a spectral shaping filter for each of a plurality of sub-bands, each sub-band of the plurality of sub-bands being within a band that includes a carrier of a set of carriers, the spectral shaping filter for a sub-band being based at least in part on an intermodulation distortion, IMD, that overlaps with at least one sub-band of the plurality of sub-bands (Block S134). The method also includes applying the spectral shaping filters to the sub-bands of the plurality of sub-bands (Block S136).

According to this aspect, in some embodiments, at least one spectral shaping filter is a digital filter having coefficients determined based at least in part on the overlapping IMD for at least one carrier of the set of carriers. In some embodiments, at least one spectral shaping filter is determined based at least in part on an effect of a selected spectral shaping filter upon the overlapping IMD for each of at least one carrier of the set of carriers. In some embodiments, the effect of the selected spectral shaping filter is indicated at least by a strength of the overlapping IMD for at least one carrier of the set of carriers. In some embodiments, the effect of the selected spectral shaping filter is indicated at least by an extent of overlap of the overlapping IMD with a sub-band of the plurality of sub-bands. In some embodiments, the selected spectral shaping filter is indicated at least by a receiver degradation metric. In some embodiments, the set of carriers includes at least one downlink carrier and at least one uplink carrier. In some embodiments, at least one spectral shaping filter is determined based at least in part on at least one of a downlink power, frequency and bandwidth and an uplink frequency and bandwidth of a carrier of the set of carriers. In some embodiments, a gain of at least one spectral shaping filter is based at least in part on a dynamic load utilization of a carrier of the set of carriers. In some embodiments, a gain of at least one spectral shaping filter varies with frequency. In some embodiments, at least one spectral shaping filter is determined in the frequency domain. In some embodiments, at least one spectral shaping filter is determined in the time domain. In some embodiments, the method includes selecting a shape of at least one spectral shaping filter from a set of spectral shaping filter shapes. In some embodiments, the IMD is estimated based at least in part on a model. In some embodiments, the model is trained according to a constrained optimization problem subject to a constraint on total downlink power.

Having described the general process flow of arrangements of the disclosure and having provided examples of hardware and software arrangements for implementing the processes and functions of the disclosure, the sections below provide details and examples of arrangements for transmit spectral shaping for reducing distortion in a receiver.

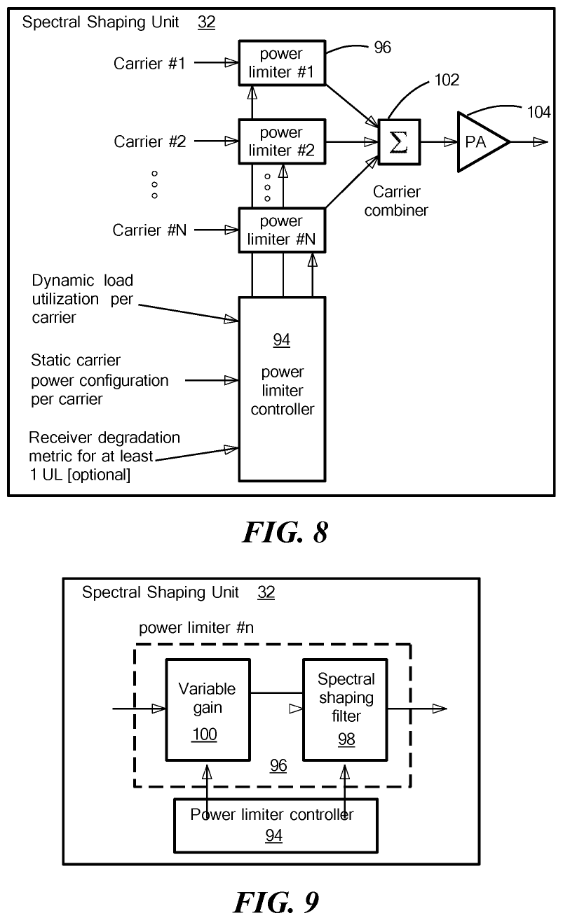

FIG. 8 is a block diagram of an example spectral shaping unit 32, which includes a power limiter controller 94 and a plurality of power limiters 96. This configuration enables power limiting per carrier or per subband. An input to the power limiter controller 94 is a receiver degradation metric. Based on the receiver degradation metric, the power limiter controller 94 determines spectral shaping filters 98 for each power limiter 96, as shown in FIG. 9. A variable gain device 100, such as an amplifier and/or attenuator, controls the amplitude of the signal input to the spectral shaping filters 98. A spectral shaping filter 98 may be or include a digital filter having coefficients that are determined by the power limiter controller 94. The variable gain device 100 is shown as a separate box. However, the functionality of the variable gain device 100 may also be implemented as part of the spectral shaping filter 98. The outputs of the power limiters 96 are combined by the carrier combiner 102 and input to the power amplifier 104. Although spectral shaping until 32 and power limiter controller 94 and power limiters 96 are shown as part of processing circuitry 68, it is understood that power limiter controller 94 and power limiters 96 can be implemented within network node 16 separate and apart from processing circuitry 68 and/or processor 70.

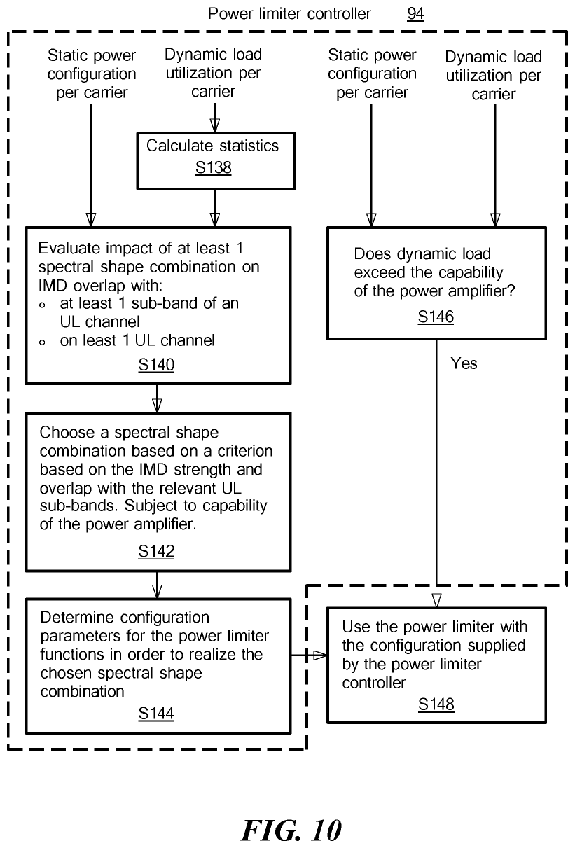

FIG. 10 illustrates an example of a process performed by the power limiter controller 94. The power limiter controller 94 received a static power configuration per carrier and a dynamic load utilization per carrier. Statistics are calculated at Block S138 based on the dynamic load per carrier. These statistics, together with the static power configuration per carrier are used to evaluate the impact upon intermodulation of a spectral filter shape (Block S140). Based on the evaluation and on spectral overlap with uplink (UL) subbands, a spectral filter shape combination to be applied to the carriers (or subbands) is selected (Block S142). The power limiter controller 94 determines configuration parameters to configure the power limiters 96 to realize the chosen spectral filter shape via the spectral shaping filters 98 (Block S144). The power limiter controller 94 also determines, based on the static power configuration per carrier and the dynamic load utilization per carrier, whether the dynamic load exceeds the capability of a power amplifier of a transmitter of the radio interface 62 (Block S146). The configuration parameters are then used to configure the power limiters 96, subject to constraints on power based on the dynamic load of the power amplifier(s). Thus, at Block S146, the power limiter controller 94 is configured to determine whether the power needs to be limited. If so, then there may need to be signaling to the impacted power limiter boxes.

The evaluation of the impact of a spectral shape upon intermodulation (IMD) is based on the configured DL carriers (power, frequency, bandwidth), as well as the configured UL carriers (frequency & bandwidth). In some embodiments, a subset of the UL band, or multiple sub-bands (as opposed to the entire UL band) may be evaluated as to the impact of the spectral shape on IMD. Optimizing over a small UL frequency range may yield a better result than optimizing over a large UL frequency range. Small UL frequency ranges are very relevant in cellular communications for things such as control channel messages (ACKS, NACKS, scheduling requests, etc.), and voice over Internet protocol (VoIP) packets during calls.

### Variations and Example Embodiments

Spectral shaping filter 98 may be applied after a carrier combiner of the radio interface 62. This would only require one place to put the spectral shaping filter 98. However, the spectral shaping filter would then need to handle all carriers which means the frequency response may be more difficult to control on a per-carrier basis. In this case, the variable gain devices 100 may be placed in the individual paths of the carriers to take some of the burden off a wideband digital filter implemented by the spectral shaping filter 98.

As noted, the evaluation of the impact upon IMD of a spectral shaping filter 98 may be based on dynamic load utilization statistics determined at Block S138. These statistics may indicate actual utilization. For example, the loads of all carriers may be averaged over time. If one of the carriers has a really low average utilization, then its impact on IMD may be de-emphasized in the IMD evaluation.

The receiver degradation metric received by the power limiter controller 94 is based on a metric that is related to the IMD. This may be used to determine how aggressive the power limiter controller should be in reducing the IMD. The aggressiveness may be related to how much variation is used in the TX shaping filter across frequency. In the case of a linear ramp, aggressiveness would correspond to the slope.

The shaping may be done in the time domain using a digital filter, or in the frequency domain using standard digital signal processing (DSP) techniques. An advantage to shaping in the frequency domain is that time domain coefficients do not need to be calculated.

It is typical to have multiple UL carriers on a radio, and multiple antenna branches. Some embodiments include a first configuration of the spectral shaping filters 98 of the power limiters 96 on a first subset of antennas, and a second different configuration of the spectral shaping filters 98 on a second subset of antennas. As an example, consider a radio with 2 frequency division duplex (FDD) frequency carriers and 4 antenna branches: the power limiter configuration on a first 2 antenna branches may be chosen to reduce IMD in the first UL channel, and the power limiter configuration on the second 2 antenna branches may be chosen to reduce the IMD in the second UL channel. A benefit of running different power limiter configurations is an ability to provide a subset of the branches with reduced IMD for each UL channel (i.e., to spread the residual IMD across both bands in some manner, instead of optimizing for one band).

### How to do the Evaluation

Options for performing the evaluation of the impact on IMD of a spectral shaping filter 98 may include one or more the following:

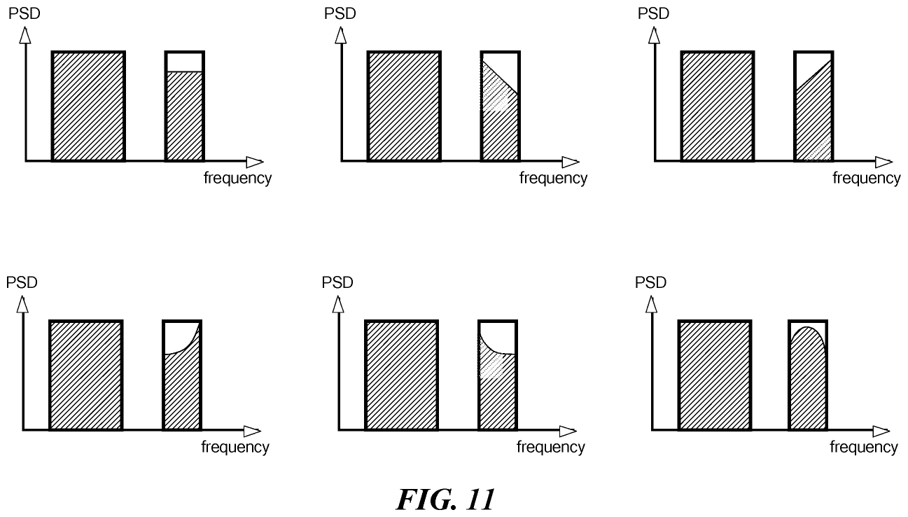

Option 1: Use a predetermined list of shapes. Each shape may be subject to constraints such as a minimum and/or maximum power spectral density (PSD) and/or minimum and/or maximum slope). The shape is then evaluated theoretically based on carrier info and a passive intermodulation (PIM) model. Some examples of predetermined PSD shapes are shown in FIG. 11 with 2 DL carriers, where only 1 carrier is shown to have TX shaping. The dashed lines show the ‘configured’ output power and represents the total maximum PSD that would occur if the power amplifier were not under-dimensioned. The shaded regions show the actual allocation of DL power within the DL carriers, which are subject to the constraint that the total power does not exceed the limit of the power amplifier.

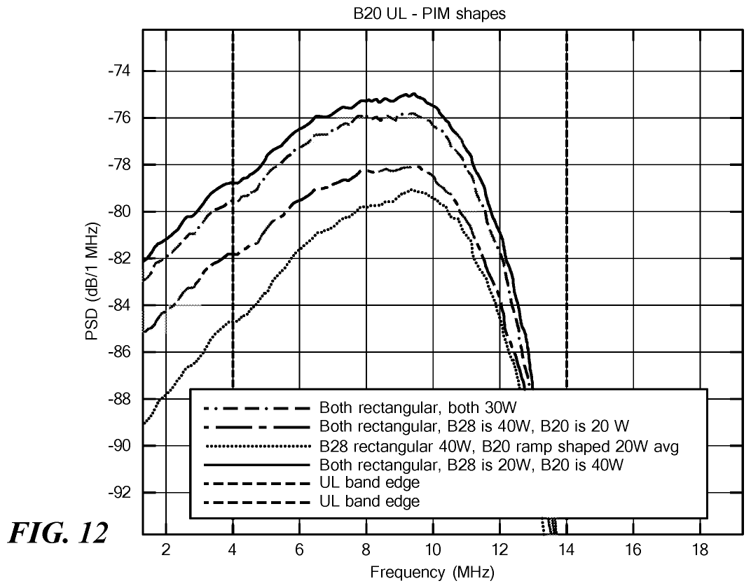

FIG. 12 is graph of IMD PSD for 4 different DL PSD power limiting options. The dashed lines indicate the boundary on an UL channel. In some embodiments, the power limiter controller 94 is configured to find a PSD power limiting option that minimizes the IMD PSD in a subset of the UL channel. The location of the UL channel would be outside of the DL PSD's in FIG. 11. In one example, the UL channel is to the right of the rightmost DL carrier in FIG. 11.

One skilled in the art may calculate the curves in FIG. 12 based on 1) DL PSD shapes (includes frequencies, bandwidths and PSD as a function of frequency), 2) a theoretical model of the IMD, and/or 3) the frequency and bandwidth of at least 1 UL channel that will be used in the optimization. The IMD model may correspond to a simple 3^{rd} order polynomial, which would model 3^{rd} order IMD. The power spectral density (PSD) of this signal may then be calculated.

Option #2: Try out different shapes and track the results with measurements Consider similar shapes as shown in FIG. 11 subject to a total power constraint. In this case, a theoretical model of the IMD is not used. Instead, a metric that is indicative of UL degradation due to IMD is measured for each of the shapes. Some examples of this type of metric are:
UL Interference plus noise metric from Layer 1;
UL noise measurement—which may be made when no UL is scheduled; and/or
UL SINR measurement.

Any UL metric that would be negatively impacted by a loss of sensitivity and/or by IMD (for example, a block error rate (BLER)). The shape that is chosen in Block 142 of the power limiter controller 94 may correspond to the shape that resulted in the best UL metric.

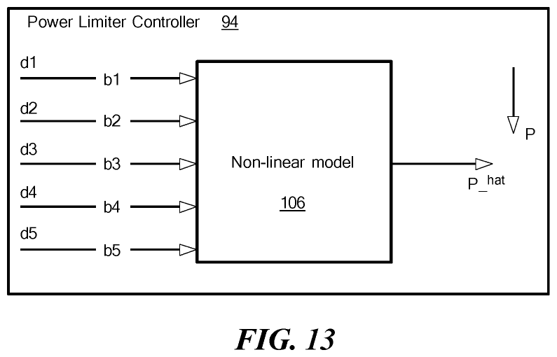

Option #3: Use measurements to train a model of the IMD, then use the trained model to find an acceptable transmit PSD shape. The calculation of the acceptable transmit PSD shape is a constrained optimization problem, where the constraint is the total DL power. A block diagram of a non-linear model 106 is shown in FIG. 13.

### Training the Mode:

Typical IQ model: this type of model refers to a model that has the IQ data of the transmit (TX) signals input to the model, and the output is IQ data that falls into the receive (RX) band. This output signal may be compared with the actual PIM in order to train the parameters of the PIM model. PIM cancellation may be used to train the model.

Power-measurement based model: An IQ model may have higher fidelity than required for IMD suppression. The PSD of the IMD is predicted using the PSD of the TX signals. In the field of supervised learning there are many options to train non-linear models. One example is a multi-layer perceptron (MLP) neural network. The inputs may be the TX PSD shape at some grid spacing (such as physical resource blocks PRBs) and the output may be the IMD PSD shape as observed in the receiver at some grid spacing (such as PRBs).

After training the model, a next step involves using the trained model to find an acceptable TX PSD shape. The trained model may be used with a list of predetermined TX shapes (similar to Option #1, but a model is not assumed in advance).

After the desired TX PSD is determined (from either of the options above), then it may be implemented by the spectral shaping filter:
If the TX filter is implemented in the time domain, then the filter coefficients based on a desired amplitude response may be determined. A requirement of a linear phase response may also be incorporated; and
If the TX filter is implemented in the frequency domain, then realization of a desire amplitude response may be simpler than implementing a digital filter in the time domain.

Some embodiments may be implemented in an open radio unit (0-RU). Some embodiments offer an alternative to under-dimensioning the power amplifiers. Some embodiments may further reduce cost of the RF filter, transmitter linearization circuitry, receiver linearity circuitry and/or passive components.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a wireless device, WD, the method comprising:
determining a spectral shaping filter for each of a plurality of sub-bands, each sub-band of the plurality of sub-bands being within a band that includes a carrier of a set of carriers, the spectral shaping filter for a sub-band being based at least in part on an intermodulation distortion, IMD, that overlaps with at least one sub-band of the plurality of sub-bands; and
applying the spectral shaping filters to the sub-bands of the plurality of sub-bands.

2. The method of claim 1, wherein at least one spectral shaping filter is a digital filter having coefficients determined based at least in part on the overlapping IMD for at least one carrier of the set of carriers.

3. The method of claim 1, wherein at least one spectral shaping filter is determined based at least in part on an effect of a selected spectral shaping filter upon the overlapping IMD for each of at least one carrier of the set of carriers.

4. The method of claim 3, wherein the effect of the selected spectral shaping filter is indicated at least by a strength of the overlapping IMD for at least one carrier of the set of carriers.

5. The method of claim 3, wherein the effect of the selected spectral shaping filter is indicated at least by an extent of overlap of the overlapping IMD with a sub-band of the plurality of sub-bands.

6. The method of claim 3, wherein the selected spectral shaping filter is indicated at least by a receiver degradation metric.

7. The method of claim 1, wherein the set of carriers includes at least one downlink carrier and at least one uplink carrier.

8. The method of claim 1, wherein at least one spectral shaping filter is determined based at least in part on at least one of a downlink power, frequency and bandwidth and an uplink frequency and bandwidth of a carrier of the set of carriers.

9. The method of claim 1, wherein a gain of at least one spectral shaping filter is based at least in part on a dynamic load utilization of a carrier of the set of carriers.

10. The method of claim 1, wherein a gain of at least one spectral shaping filter varies with frequency.

11. The method of claim 1, wherein at least one spectral shaping filter is determined in the frequency domain.

12. The method of claim 1, wherein at least one spectral shaping filter is determined in the time domain.

13. The method of claim 1, further comprising selecting a shape of at least one spectral shaping filter from a set of spectral shaping filter shapes.

14. The method of claim 1, wherein the IMD is estimated based at least in part on a model.

15. The method of claim 14, wherein the model is trained according to a constrained optimization problem subject to a constraint on total downlink power.

16. A network node configured to communicate with a wireless device, WD, the network node comprising:
a power limiter controller configured to determine a spectral shaping filter for each of a plurality of sub-bands, each sub-band of the plurality of sub-bands being within a band that includes a carrier of a set of carriers, the spectral shaping filter for a sub-band being based at least in part on an intermodulation distortion, IMD, that overlaps with at least one sub-band of the plurality of sub-bands; and
a plurality of power limiters in communication with the power limiter controller, each power limiter configured to apply a spectral shaping filter to a sub-band of the plurality of sub-bands.

17. The network node of claim 16, wherein at least one spectral shaping filter is a digital filter having coefficients determined based at least in part on the overlapping IMD for at least one carrier of the set of carriers.

18. The network node of claim 16, wherein at least one spectral shaping filter is determined based at least in part on an effect of a selected spectral shaping filter upon the overlapping IMD for each of at least one carrier of the set of carriers.

19. The network node of claim 18, wherein the effect of the selected spectral shaping filter is indicated at least by a strength of the overlapping IMD for at least one carrier of the set of carriers.

20. The network node of claim 18, wherein the effect of the selected spectral shaping filter is indicated at least by an extent of overlap of the overlapping IMD with a sub-band of the plurality of sub-bands.

21.-30. (canceled)
